(19) United States
(12) Patent Application Publication
(10) Pub. No.: US 2014/0054877 A1
(43) Pub. Date: Feb. 27, 2014

(54) Method And System For Towing A Vehicle Behind Another Vehicle

(71) Applicant: Lloyd Ammuel Adams, III, Stonewall, OK (US)

(72) Inventor: Lloyd Ammuel Adams, III, Stonewall, OK (US)

(21) Appl. No.: 13/967,475

(22) Filed: Aug. 15, 2013

Related U.S. Application Data
(60) Provisional application No. 61/691,518, filed on Aug. 21, 2012.

(51) Int. Cl. B60D 1/06

(52) U.S. Cl. CPC B60D 1/06
USPC 280/511

(57) ABSTRACT

The present invention is directed to a towing system for towing a first vehicle behind a second vehicle. The towing system comprises a first vehicle comprising a receiver hitch, a second vehicle comprising a hitch lift, and a link. The link may be secured to the receiver hitch and a hitch. The towing system tows a rear end of the first vehicle behind a rear end of the second vehicle without the use of a trailer or excessive fasteners and connections.

### CROSS REFERENCE TO RELATED APPLICATION

This application claims the benefit of provisional patent application Ser. No. 61/691,518, filed on Aug. 21, 2012, the entire contents of which are incorporated herein by reference.

### FIELD OF THE INVENTION

The present invention relates generally to a towing system for the towing of a first vehicle behind a second vehicle.

### SUMMARY OF THE INVENTION

The present invention is directed to a towing system for towing a first vehicle behind a second vehicle. The towing system comprises a receiver hitch supported on a rear end of the first vehicle, a ball supported on a rear end of the second vehicle, and a link comprising an arm and a mount. The arm is connectable to the receiver hitch of the first vehicle, and the mount is connectable to the ball of the second vehicle such that the first vehicle may be towed by the second vehicle.

The present invention is also directed to a method for towing a first vehicle behind a second vehicle using a link comprising an arm and a mount. The method comprises the steps of connecting the arm to a receiver hitch supported on a rear end of the first vehicle, connecting the mount to a ball supported on a rear end of the second vehicle, and raising a portion of the first vehicle using a lift supported on the second vehicle. The method further comprises the steps of securing alignment of the first vehicle and operating the second vehicle such that the first vehicle is pulled behind the second vehicle.

The present invention is further directed to a link for connecting a first vehicle to a second vehicle. The link comprises an arm and a mount. The arm comprises a first end, a second end, an elbow, and a pin. The mount comprises a downward-facing central opening and a pin. The mount is connected to the second end of the arm, the first end of the arm is connectable to the first vehicle, and the mount is connectable to the second vehicle.

### BRIEF DESCRIPTION OF THE DRAWINGS

FIG. 1 is an illustration of two vehicles using a towing system.

FIG. 2 is side view of a link from the towing system.

FIG. 3 is a bottom view of the link.

FIG. 4 is a detailed view of the link connected to a first vehicle.

FIG. 5 is a detailed view of the towing system.

FIG. 6 is a front view of the first vehicle with a pair of tail lights.

FIG. 7 is a perspective view of an alignment locking mechanism of the towing system.

### DESCRIPTION OF THE PREFERRED EMBODIMENT

There are many different ways to tow a vehicle, including pulling the second vehicle onto a flat-bed trailer or truck behind the first vehicle, utilizing a hook, chains, and boom to tow the second vehicle on one axle, utilizing a dolly or wheel-lift to lift and cradle a set of tires off of the ground, or utilizing tow bars which may fasten to the bumper or undercarriage of the second vehicle and leave all four tires of the second vehicle on the ground. However, these towing methods require additional large equipment or multiple fasteners and connections. The present invention allows a vehicle to tow another vehicle without the use of large equipment or multiple fasteners and connections by utilizing a single link.

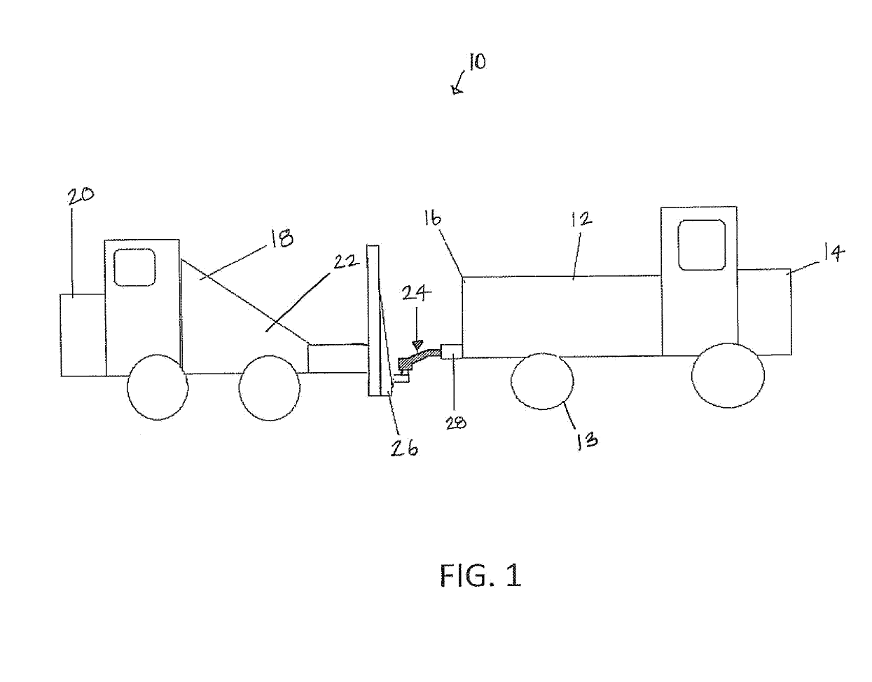

Turning now to the figures and first to FIG. 1, a towing system 10 is shown. The towing system 10 comprises a first vehicle 12, a second vehicle 18, and a link 24. The first vehicle 12 comprises tires 13, a front end 14, and a rear end 16. The second vehicle 18 comprises a front end 20 and a rear end 22. The link 24 is shown connecting the rear end 16 of the first vehicle 12 to the rear end 22 of the second vehicle 18. The link 24 may connect to the second vehicle 18 at a connection point. The connection point shown in FIG. 1 is a hitch lift 26. The hitch lift 26 may be configured such that it can raise and lower the link 24 as desired. The link 24 may connect to the rear end 16 of the first vehicle 12 at a connection point. The connection point shown in FIG. 1 is a receiver hitch 28. One of skill in the art will recognize that the connection points may be of any shape and size as long as the link 24 may adequately secure to each connection point.

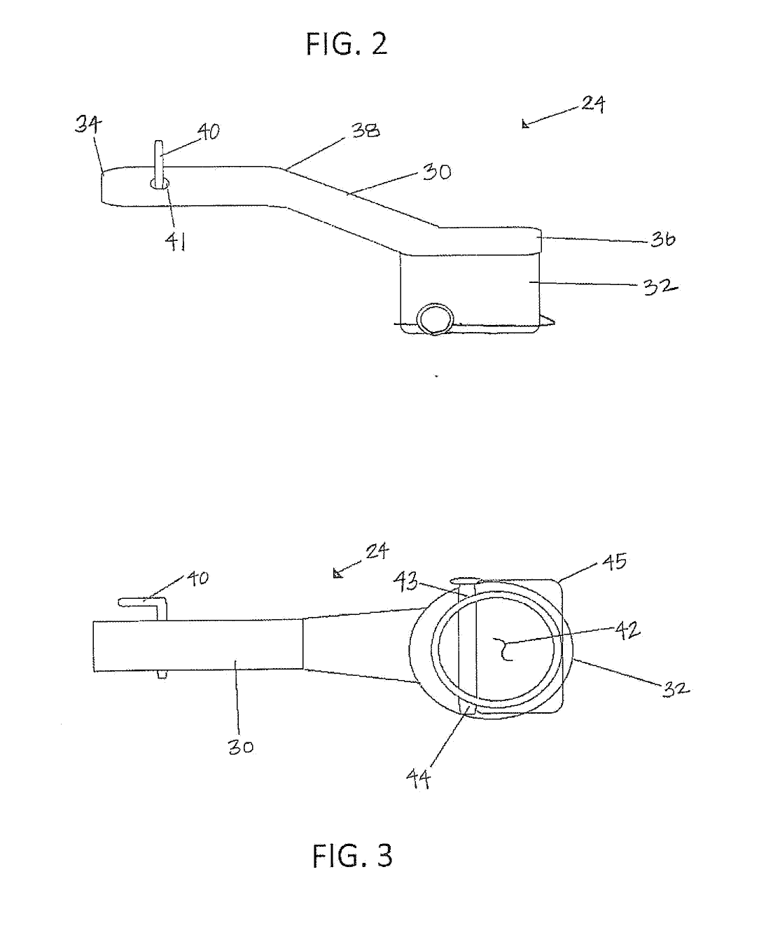

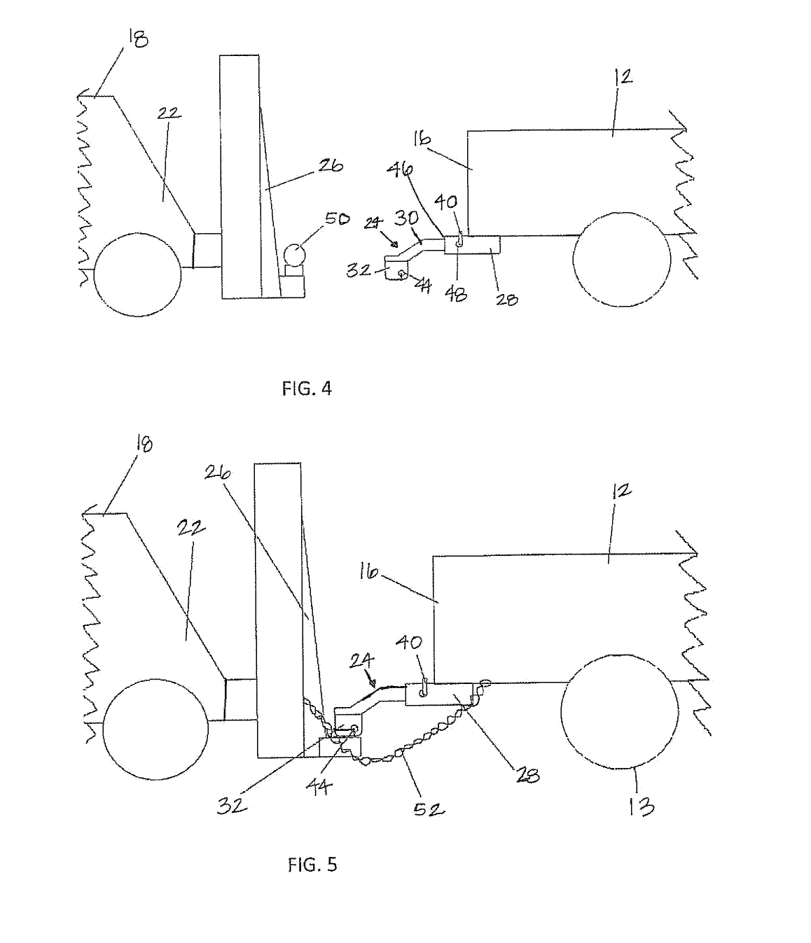

Turning to FIG. 2, a side view of the link 24 is shown. The link 24 comprises an arm 30 and a mount 32. The arm 30 comprises a first end 34, a second end 36, and an elbow 38. One skilled in the art will appreciate that the degree in bend of the elbow 38 may vary depending on the particular towing operations or the arm 30 may not include an elbow at all. The arm 30 further comprises a pin 40 proximate the first end 34. The pin 40 passes through the width of the arm 30 through a pin hole 41 for connection to the connection point or receiver hitch 28, as shown in FIG. 4. The mount 32 is connected to the second end 36 of the arm 30. The mount 32 may be welded to the arm 30 or may be connected via any means capable of adequately securing the mount to the second end 36 of the arm. The arm 30 and the mount 32 may also be formed as one solid integral piece.

Referring now to FIG. 3, a bottom view of the link 24 is shown. The mount 32 comprises a downward-facing central opening 42 and a pin 44. The pin 44 passes through the width of the mount 32 through a pin hole 43 to secure the link 24 to the connection point of hitch lift 26 on the rear end 22 of the second vehicle 18, as shown in FIG. 4. A pin lock 45 extends around the mount 32 and is connected to both ends of the pin 44 in order to hold the pin in place.

Turning now to FIG. 4, the receiver hitch 28 attached to the rear end 16 of the first vehicle 12 is shown. The receiver hitch 28 comprises a central opening 46 and a pin hole 48. The link 24 is also shown in FIG. 4. The link 24 is inserted into the central opening 46 of the receiver hitch 28. The pin 40 of the arm 30 is shown passing through the pin hole 48 of the receiver hitch 28 and through pin hole 41 in the arm 30 (FIG. 2). The pin 40 secures the link 24 to the receiver hitch 28. One skilled in the art may appreciate that other means may be used to secure the link 24 to the receiver hitch or connection point 28, such as bolts or screws.

As shown in FIG. 4, the hitch lift 26 is attached to the rear end 22 of the second vehicle 18. The hitch lift 26 comprises a ball 50. The ball 50 may be inserted into the downward-facing central opening 42 (FIG. 3) of the mount 32. The pin 44 may be passed through pin hole 43 (FIG. 3) in the mount 32 such that the pin 44 secures the ball 50 within the downward-facing central opening 42 of the mount. The hitch lift 26 is configured to raise and lower the ball 50 and in turn raise and lower the link 24. Raising and lowering the link 24 raises and lowers the rear end 16 of the first vehicle 12. The hitch lift 26 is raised manually or hydraulically until it can be locked in place at a desired height.

Turning now to FIG. 5, the mount 32 is shown secured to the ball 50 (FIG. 4) of the hitch lift 26. The link 24 is inserted into the receiver hitch 28 of the first vehicle 12. The pin 40 and the pin 44 secure the arm 30 to the receiver hitch 28 and secure the mount 32 to the ball 50. A set of chains 52 are connected at one end to the hitch lift 26 and at a second end to the receiver hitch 28. The chains 52 provide a backup mechanism in case the first vehicle 12 becomes disconnected from the second vehicle 18 during towing operations. One skilled in the art may also appreciate that the link 24 may be used between a receiver hitch 28 and a second receiver hitch comprising a ball 50; a separate hitch lift 26 is not required.

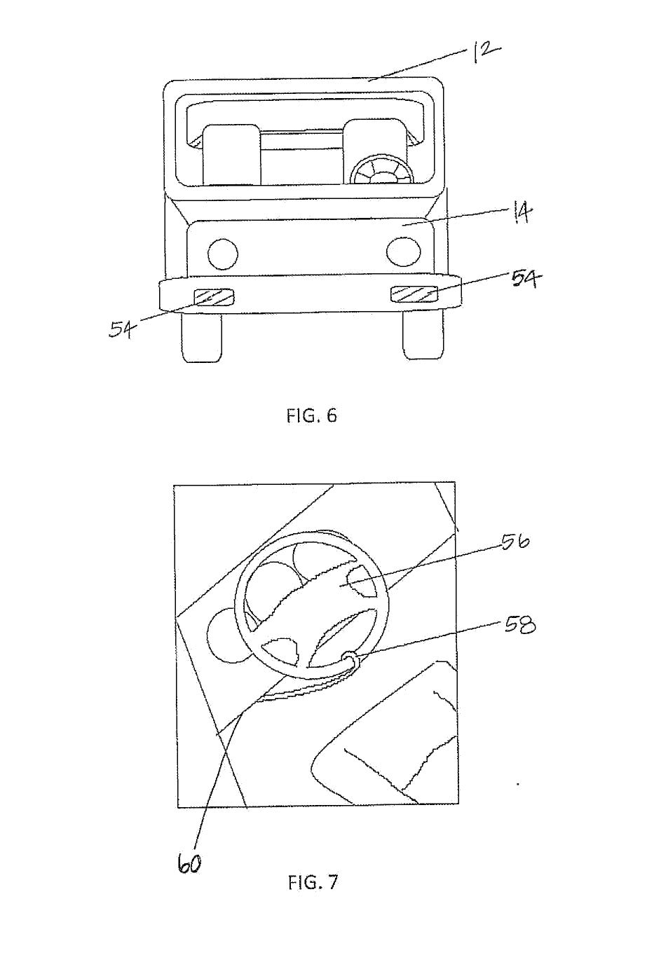

Referring now to FIG. 6, the front end 14 of the first vehicle 12 is shown. A pair of tail lights 54 is attached to the front end 14 of the first vehicle 12. The tail lights 54 work to illuminate the vehicle being towed during operation. The tail lights 54 may preferably attach magnetically to the front end 14 of the first vehicle 12. One skilled in the art will appreciate tail lights 54 may be attached by any means necessary to secure them to the front end 14 of the first vehicle 12. Turning now to FIG. 7, a steering wheel 56 of the first vehicle 12 (FIG. 1) is shown. An alignment locking mechanism 58 secures the steering wheel 56 to an inside portion 60 of the first vehicle 12. The alignment locking mechanism 58 holds the steering wheel 56 in place during operation. Locking the steering wheel 56 maintains alignment of the tires 13 on the first vehicle 12 (FIG. 1). This ensures that the first vehicle 12 will stay aligned with the second vehicle 18 during towing operations.

In operation, the first vehicle 12 is placed in neutral and the alignment locking mechanism 58 is secured to the steering wheel 56. Tail lights 54 are secured to the front end 14 of the first vehicle 12. The arm 30 of the link 24 is inserted into the central opening 46 of the receiver hitch 28 and secured with the pin 40. The ball 50 of the hitch lift 26 is inserted into the downward-facing central opening 42 of the mount 32 and secured with the pin 44. Chains 52 are attached between the hitch lift 26 and the receiver hitch 28. The ball 50 of the hitch lift 26 is raised to a desired height. Preferably the first vehicle 12 will be raised at least six inches from the ground. The raising of the ball 50 in turn raises the link 24 which in turn raises the rear end 16 and the rear tires 13 of the first vehicle 12 off of the ground. The first vehicle 12 is then rested at an angle with only its two front tires on the ground. One skilled in the art will appreciated that a truck with more than two sets of tires may have more tires left on the ground depending on how high the hitch lift 26 is raised. The hitch lift 26 may also remain in place or be lowered as desired such that all of the tires of the first vehicle remain on the ground during towing operations.

Once the first vehicle 12 is secured behind the second vehicle 18 as desired, the second vehicle is free to be driven to a desired location, towing the first vehicle behind the second vehicle. Once at the desired location, the hitch lift 26 is adjusted as needed such that all of the tires of the first vehicle 12 are set firmly on the ground. The chains 52 and pins 40 and 44 are then removed. The mount 32 is then lifted off of the ball 50 and the link 24 is removed from the receiver hitch 28. The tail lights 54 and the alignment locking mechanism 58 are removed from the first vehicle 12 and the first vehicle is free to operate on its own as needed.

The present invention allows for the towing of a vehicle behind another vehicle without using of a plurality of fasteners and connections or requiring a trailer or additional equipment. It should be understood that various changes, substitutions and alterations can be made therein without departing from the spirit and scope of the invention as defined by the appended claims.

What is claimed is:

1. A towing system for towing a first vehicle behind a second vehicle, the towing system comprising:
a receiver hitch supported on a rear end of the first vehicle;
a ball supported on a rear end of the second vehicle;
a link comprising an arm and a mount;
wherein the arm is connectable to the receiver hitch of the first vehicle; and
wherein the mount is connectable to the ball of the second vehicle such that the first vehicle may be towed behind the second vehicle.

2. The towing system of claim 1 wherein the receiver hitch comprises a central opening, wherein the arm is connectable to the receiver hitch by inserting the arm into the central opening of the receiver hitch.

3. The towing system of claim 2 further comprising a pin for connecting the arm to the receiver hitch.

4. The towing system of claim 1 further comprising a connector for connecting the ball and the mount.

5. The towing system of claim 4 wherein connector comprises a downward-facing central opening in the mount.

6. The towing system of claim 4 wherein the connector comprises a pin.

7. The towing system of claim 1 further comprising a lift supported on the rear end of the second vehicle, wherein the lift moves the ball relative to the second vehicle.

8. The towing system of claim 1 further comprising an alignment locking mechanism to secure a steering wheel of the first vehicle in place to maintain alignment of the first vehicle.

9. The towing system of claim 1 further comprising tail lights to be placed on a front end of the first vehicle.

10. The towing system of claim 1 wherein the mount is welded to the arm.

11. The towing system of claim 1 wherein the mount is integral with the arm.

12. The towing system of claim 1 wherein the arm comprises an elbow.

13. A method for towing a first vehicle behind a second vehicle using a link comprising an arm and a mount, the method comprising the steps of:
connecting the arm to a receiver hitch supported on a rear end of the first vehicle;
connecting the mount to a ball supported on a rear end of the second vehicle;
raising a portion of the first vehicle using a lift supported on the second vehicle;
securing alignment of the first vehicle; and
operating the second vehicle such that the first vehicle is pulled behind the second vehicle.

14. The method of claim 13 further comprising connecting the link to the first vehicle using a pin.

15. The method of claim 13 further comprising connecting the mount to a ball on the rear end of the second vehicle.

16. The method of claim 15 further comprising connecting the mount to the ball by inserting the ball into a downward-facing central opening of the mount.

17. The method of claim 15 further comprising connecting the mount to the ball of the second vehicle using a pin.

18. The method of claim 15 further comprising attaching tail lights to a front end of the first vehicle.

19. The method of claim 15 further comprising attaching an alignment locking mechanism to a steering wheel of the first vehicle to secure alignment of the first vehicle.

20. A link for connecting a first vehicle to a second vehicle comprising:
an arm comprising first end, a second end, an elbow, and a pin;
a mount comprising a downward-facing central opening and a pin;
wherein the mount is connected to the second end of the arm;
wherein the first end of the arm is connectable to the first vehicle; and
wherein the mount is connectable to the second vehicle.
